(19) United States
(12) Patent Application Publication
(10) Pub. No.: US 2011/0316791 A1
(43) Pub. Date: Dec. 29, 2011

(54) TOUCH PAD CHARACTER ENTERING SYSTEM AND METHOD

(76) Inventor: Peigen Jiang, Sammamish, WA (US)

(21) Appl. No.: 12/824,202

(22) Filed: Jun. 27, 2010

(51) Int. Cl. G06F 3/041

(52) U.S. Cl. 345/173

(57) ABSTRACT

A touch pad character entering system and method are disclosed. The system comprises a touch pad configured to detect contacts by an object thereon, a coordinate extraction module configured to extract coordinates of the contact locations detected by the touch pad, and a processing unit configured to obtain an initial contact coordinate and a subsequent movement by the object in contact with the touch pad from the extracted contact coordinates, select a predetermined group of characters based on the initial contact coordinate, and select a predetermined character from the predetermined group of characters based on the subsequent movement.

### BACKGROUND

The present invention relates generally to keyboards for entering characters into electronic devices, and, more particularly, to a touch-type keyboard with reduced number of keys.

Keyboard is the most common device for entering text or instructions into a computational electronic device such as a computer. In general, a keyboard has a plurality of keys, and a single character is assigned to each of the keys. In some cases, a single key can be used to enter two different characters by combining with another key. For instance, when a “Shift” key and a regular letter key are pressed at the same, a capital letter that key represents is entered. FIG. 1 illustrates a conventional touch pad keyboard 100 for entering letters into a handheld device. The surface area of the touch pad 100 is divided into a plurality of marked regions. Each region represents a letter. For instance, a region 110 represents English letter Z. Once a finger touches the region 110, letter Z is entered into the handheld device.

Since English language, as well as many other languages, has twenty six letters, the conventional touch pad keyboard 100 would need to be divided into at least 26 regions. Then each region has to be relatively small, and can be difficult for adult finger to touch precisely.

As such, what is desired is a system and method to reduce the number of keys required to enter characters in a small form-factor electronic device.

### SUMMARY

The present invention discloses a touch pad character entering system and method. The system comprises a touch pad configured to detect contacts by an object thereon, a coordinate extraction module configured to extract coordinates of the contact locations detected by the touch pad, and a processing unit configured to obtain an initial contact coordinate and a subsequent movement by the object in contact with the touch pad from the extracted contact coordinates, select a predetermined group of characters based on the initial contact coordinate, and select a predetermined character from the predetermined group of characters based on the subsequent movement.

The construction and method of operation of the invention, however, together with additional objects and advantages thereof, will be best understood from the following description of specific embodiments when read in connection with the accompanying drawings.

### BRIEF DESCRIPTION OF THE DRAWING

FIG. 1 illustrates a conventional touch pad keyboard for entering letters into a handheld device.

FIG. 2 illustrates a touch pad keyboard with each key region being able to enter multiple characters according to an embodiment of the present invention.

FIG. 3 illustrates finger motions on one of the key regions of FIG. 2.

FIG. 4 is a block diagram of a character entering system implementing the touch pad keyboard of FIG. 2.

FIG. 5 is a flow chart illustrating operation steps for implementing the touch pad keyboard of FIG. 2.

The drawings accompanying and forming part of this specification are included to depict certain aspects of the invention. A clearer conception of the invention, and of the components and operation of systems provided with the invention, will become more readily apparent by referring to the exemplary, and therefore non-limiting, embodiments illustrated in the drawings, wherein like reference numbers (if they occur in more than one view) designate the same elements. The invention may be better understood by reference to one or more of these drawings in combination with the description presented herein.

### DESCRIPTION

The following will provide a detailed description of a touch pad keyboard for entering large number of characters with reduced number of keys.

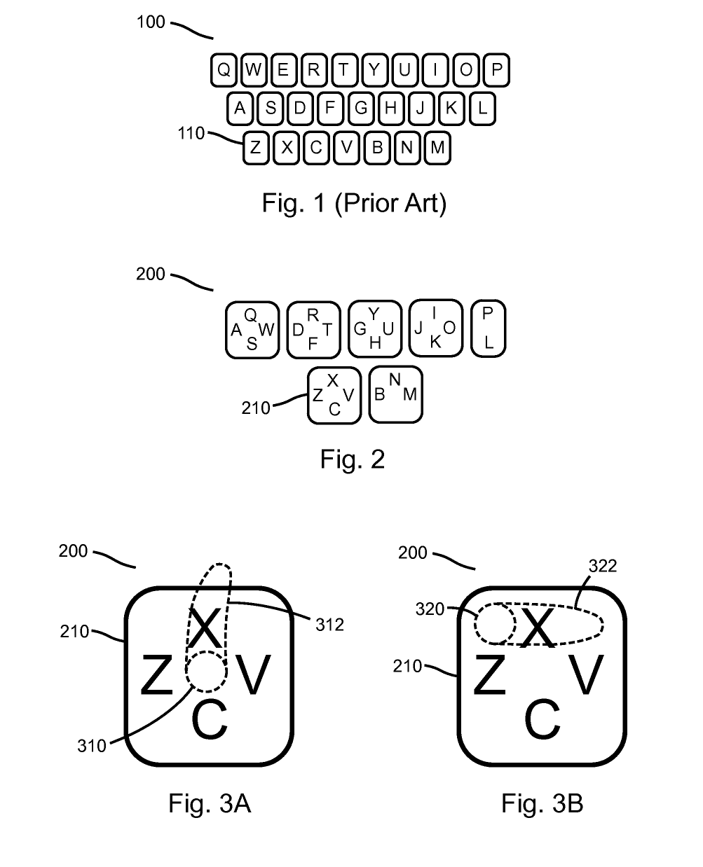

FIG. 2 illustrates a touch pad keyboard 200 with each key region capable for entering multiple characters according to an embodiment of the present invention. For instance, one of the key regions 210 can be used to enter four letters: Z, X, C, V. As a result, twenty six letters will require only seven key regions, which is a significant reduction in the number of key regions. Therefore, each key region 210 can be larger than the conventional key region 110 of FIG. 1, or a size of the touch pad keyboard 200 can be smaller than the conventional touch pad keyboard 100 of FIG. 1.

FIG. 3 illustrates finger motions on one of the key regions 210 of FIG. 2. Referring to FIG. 3A, a spot 310 represents an initial touch area by a finger (not shown) on the key region 210. The spot 310 is at approximately a center of the key region 210. A path 312 represents a slide path following the initial touch by the finger on the touch pad 200, i.e., the finger was sliding upward. Combining the facts that the finger initially touches the key region 210 and then slides upward on the touch pad 200, this particular finger operation is interpreted as entering letter X according to the embodiment of the present invention.

Referring back to FIG. 3A, the path 312 goes to outside of the key region 210 and may enter into a neighboring key region (not shown). As long as the finger maintains contact with the touch key board 200 throughout the slide path 312, any subsequent finger location is not considered initial contact location. For entering another character, a user has to lift his or her finger off the touch key board 200 and then makes another initial contact with the touch key board 200.

Referring to FIG. 3B, spot 320 represents another initial touch area by a finger (not shown) on the key region 210. Even though the spot 320 is not centered, it is still within the key region 210. A path 322 represents a slide path following the initial touch by the finger on the touch pad 200, i.e., the finger was sliding toward a right. Combining the facts that the finger initially touches the key region 210 and then slides toward the right, this particular finger operation is interpreted as entering letter V according to the embodiment of the present invention.

Referring to both FIGS. 3A and 3B, although the key region 210 is shown to be able to enter four different letters, one having ordinary skill in the art would recognize that more than four letters can be entered by the single key region 210 as long as the same number of finger slide directions can be effectively distinguished. For instance, when diagonal slide directions, as well as the orthogonal slide directions, are employed, a single key region can represent a total of eight letters.

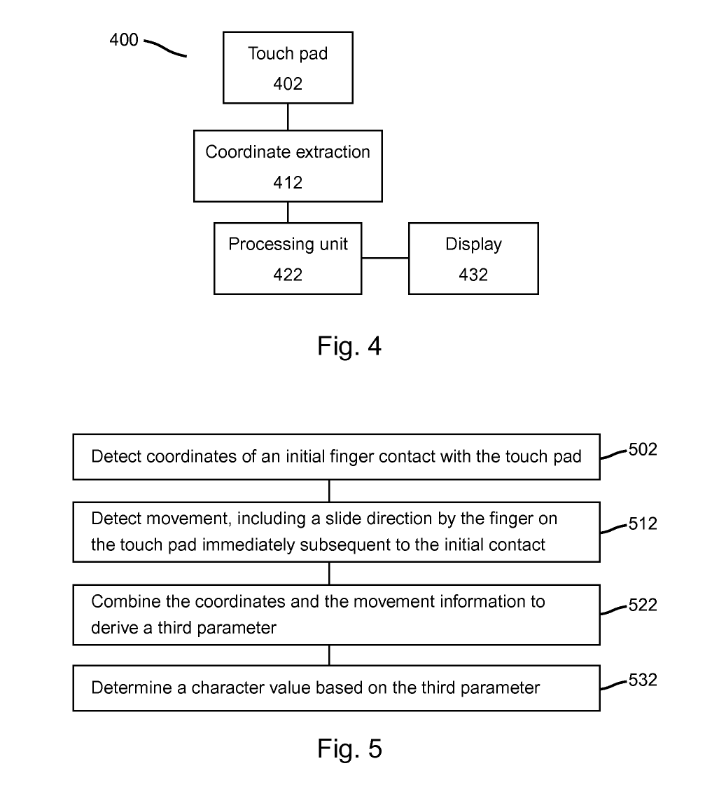

FIG. 4 is a block diagram of a character entering system 400 implementing the touch pad keyboard 200 of FIG. 2. The character entering system 400 include a touch pad 402, a coordinate extraction module 412, a processing unit 422 and an optional display 432. The touch pad 402 is a well known pointing device comprising a specialized surface that can continuously sense locations of a user's finger on the touch pad 402. Signals generated by the touch pad 402 corresponding to the finger touch locations are then sent to the coordinate extraction module 412 which translate the signals into coordinate values. The processing unit 422 detects a coordinate of a finger's initial contact location, and then detects a finger slide direction immediately following the initial contact. The processing unit 422 then combines the initial contact coordinate with the finger slide direction to determine which letter the finger intends to enter. According to the embodiment of the present invention, the initial contact coordinate selects a predetermined group of letters. The slide direction selects a particular letter from the predetermined group of letters. For instance, referring back to FIG. 3A, the spot 310 is translated into an initial contact coordinate. Since the spot 310 is within the key region 210, then the spot 310 selects the group of letters: Z, X, C, V. The slide path 312 is translated as an upward slide direction, then letter X is determined to be the letter the finger is intended to enter. In a touch pad in which a display screen overlays key regions, the optional display unit 432 may display the selected letter X in proximity of the initially contacted key region to confirm the righteousness of the key stroke.

In detecting the initial contact coordinate and the slide direction, fuzzy logic and/or other optimization program may be applied to determine best values for these parameters. In case that a key stroke includes only an initial contact by a finger without any slide motion following the initial contact and before the finger being lifted away from the touch pad keyboard 200, the character entering system 400 may not be able to determine a selected letter for the key stroke. An alternative is to assign a default letter to a key region, when there is no finger slide being detected after an initial contact and before the finger is lifted, the default letter is then determined to be entered. Another option is to assign a different letter to a contact-only-and-no-slide key stroke. For instance, referring back to FIG. 3A, a numerical character “0” may be assigned to the key region 210 for a contact-only-and-no-slide key stroke in addition to the aforementioned four letters.

FIG. 5 is a flow chart illustrating operation steps for implementing the touch pad keyboard of FIG. 2. In step 502, an initial finger contact with the touch pad is detected and coordinates of the initial contact spot is extracted. In step 512, finger movement information, including a slide direction on the touch pad immediately subsequent to the initial contact is detected. Here the movement that immediately subsequent to the initial contact is chosen to be detected because that period of finger movement is most representative of a user's intension in terms of character entering. A user may slide his or her finger sequentially in different directions after an initial contact, but only the first direction that counts according to the embodiment of the present invention. Apparently, this is only a design choice, or a best mode of operation.

In step 522, the initial contact coordinates and the subsequent finger movement information are combined to derive a third parameter. In step 532, a character value is determined, i.e., a character is selected, based on the third parameter.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

What is claimed is:

1. A system for entering characters into an electronic device, the system comprising:
a touch pad configured to detect contacts by an object thereon;
a coordinate extraction module configured to extract coordinates of the contact locations detected by the touch pad; and
a processing unit configured to obtain an initial contact coordinate and a subsequent movement by the object in contact with the touch pad from the extracted contact coordinates, and combine the initial contact coordinate and the subsequent movement to determine a unique character value based on a predetermined criterion.

2. The system of claim 1, wherein the touch pad has a touch sensitive surface and an overlaying display.

3. The system of claim 1, wherein each contact location is represented by one or two coordinates.

4. The system of claim 1, wherein the object is a user finger or a magnetic stylus.

5. The system of claim 1, wherein the touch pad is divided into certain regions with displays showing characters the regions are used for entering the respective characters.

6. The system of claim 1, wherein the subsequent movement is a slide direction of the object in contact with the touch pad.

7. The system of claim 1, wherein the subsequent movement is a no-motion by the object in contact with the touch pad before the object being lifted off the touch pad.

8. The system of claim 1, wherein the subsequent movement is a movement by the object immediately subsequent to the initial contact.

9. The system of claim 1, wherein the predetermined criterion includes using the initial contact coordinate to select a predetermined group of characters, and using the subsequent movement to select a predetermined character from the predetermined group of characters.

10. A system for entering characters into an electronic device, the system comprising:
a touch pad configured to detect contacts by an object thereon;
a coordinate extraction module configured to extract coordinates of the contact locations detected by the touch pad; and
a processing unit configured to obtain an initial contact coordinate and a subsequent movement by the object in contact with the touch pad from the extracted contact coordinates, select a predetermined group of characters based on the initial contact coordinate, and select a predetermined character from the predetermined group of characters based on the subsequent movement.

11. The system of claim 10, wherein the subsequent movement is a slide direction of the object in contact with the touch pad.

12. A method for entering characters into an electronic device, the method comprising:
detecting contact locations of an object in contact with a touch pad;
extracting coordinates of the contact locations;
obtaining an initial contact coordinate and a subsequent movement of the object in contact with the touch pad; and
determining a character value based on a combination of the initial contact coordinate and the subsequent movement according to a predetermined criterion.

13. The method of claim 12, wherein the touch pad has a touch sensitive surface and an overlaying display.

14. The method of claim 12, wherein each contact location is represented by one or two coordinates.

15. The method of claim 12, wherein the object is a user finger or a magnetic stylus.

16. The method of claim 12, wherein the touch pad is divided into certain regions with displays showing characters the regions are used for entering the respective characters.

17. The method of claim 12, wherein the subsequent movement is a slide direction of the object in contact with the touch pad.

18. The method of claim 12, wherein the subsequent movement is a no-motion by the object in contact with the touch pad before the object being lifted off the touch pad.

19. The method of claim 12, wherein the subsequent movement is a movement by the object immediately subsequent to the initial contact.

20. The method of claim 12, wherein the predetermined criterion includes using the initial contact coordinate to select a predetermined group of characters, and using the subsequent movement to select a predetermined character from the predetermined group of characters.
